(19) United States
(12) Patent Application Publication
(10) Pub. No.: US 2026/0045240 A1
(43) Pub. Date: Feb. 12, 2026

(54) GUITAR HANGER

(71) Applicant: GuitUp, LLC, Ivins, UT (US)

(72) Inventor: Kelli Holzer, Ivins, UT (US)

(73) Assignee: GuitUp, LLC, Ivins, UT (US)

(21) Appl. No.: 19/288,147

(22) Filed: Aug. 1, 2025

Related U.S. Application Data
(60) Provisional application No. 63/679,981, filed on Aug. 6, 2024.

(51) Int. Cl. G10G 5/00

(52) U.S. Cl. CPC G10G 5/00

(57) ABSTRACT

A guitar hanger features a housing having a guitar mount receiver, and a base member couplable to the housing, the base member having a receiving aperture and one or more anti-slip portions. The base member further includes one or more threaded receivers for receiving screws of a guitar mount that is coupled to the guitar mount receiver. A user may install a drywall hook, small screw, nail, or other wall anchor and may then hang the guitar hanger thereon by utilizing the receiving aperture on the base member. By utilizing a single securing point to the wall, less damage to the wall occurs and the guitar hanger self-levels.

### CROSS-REFERENCE TO RELATED APPLICATIONS

This application claims the benefit of U.S. Provisional Application Ser. No. 63/679,981, filed on Aug. 6, 2024, which is incorporated herein by reference.

### TECHNICAL FIELD

The present disclosure relates to guitar hangers. More particularly, the present disclosure relates to an apparatus configured to hang a guitar on a wall without the need for drilling large holes.

### BACKGROUND

Guitars are among the most popular musical instruments worldwide, cherished for their versatility and expressive range. However, their relatively large size necessitates careful storage to prevent damage. Traditionally, many guitar owners use cases to protect their instruments, storing these cases in corners, closets, or other designated areas within their homes. This conventional method, while effective in protecting the guitar, often consumes valuable space that could be otherwise utilized.

In addition to the practical aspect of storage, many guitar enthusiasts prefer to display their instruments prominently when not in use. Displaying a guitar not only showcases the instrument as a piece of art but also keeps it easily accessible for spontaneous playing. To meet this desire, various wall hangers have been developed to hold guitars securely on walls.

Despite the availability of numerous wall hangers, each with its own design and features, they all exhibit significant drawbacks. One common type of wall hanger consists of a small wall bracket with a pair of support arms designed to cradle the neck of the guitar, allowing the headstock to rest on the support arms. While functional, these brackets require the user to drill large holes into the wall to secure the screws or anchors necessary for mounting, which is not ideal for a homeowner. This requirement can be particularly problematic for renters and landlords, as the holes must be repaired before the property can be re-let, leading to additional work and potential damage to the wall. Additionally, it can be challenging to ensure proper leveling before drilling and securing the holder.

Given these challenges, there is a clear need for an improved guitar hanger that eliminates the necessity of drilling multiple holes into a wall or other surfaces, and that is more easily leveled. Such a solution would be beneficial not only for preserving wall integrity, but also for providing a more convenient and aesthetically pleasing method of displaying and storing guitars. The present disclosure seeks to solve these and other problems.

### SUMMARY OF EXAMPLE EMBODIMENTS

In some embodiments, a guitar hanger comprises a housing comprising a guitar mount receiver, and a base member couplable to the housing, the base member comprising a receiving aperture and one or more anti-slip portions. The base member further comprises one or more threaded receivers for receiving screws of a guitar mount that is coupled to the guitar mount receiver. A user may install a drywall hook, small screw, nail, or other wall anchor and may then hang the guitar hanger thereon by utilizing the receiving aperture on the base member. By utilizing a single securing point to the wall, less damage to the wall occurs and the guitar hanger self-levels, among other things.

### BRIEF DESCRIPTION OF THE DRAWINGS

FIG. 1 illustrates a front, right-side, exploded perspective view of a guitar hanger;

FIG. 2 illustrates a front elevation view of a guitar hanger;

FIG. 3 illustrates a rear elevation view of a guitar hanger;

FIG. 4 illustrates a left side elevation view of a guitar hanger, the right side being a mirror image thereof;

FIG. 5 illustrates a top plan view of a guitar hanger, the bottom plan view being a mirror image thereof;

FIG. 6 illustrates a rear, right-side perspective view of a guitar hanger;

FIG. 7 illustrates a rear, right-side exploded perspective view of a guitar hanger;

FIG. 8 illustrates a front perspective view of a guitar hanger mounted to a wall;

FIG. 9 illustrates a front perspective view of a guitar hanger mounted to a wall and holding a guitar; and

FIG. 10 illustrates a guitar hanger in the process of being mounted on a drywall hook in a wall.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation.

Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,”etc.).

As previously discussed, there is a need for a guitar hanger that does not require drilling multiple holes into a wall or other surface, and that facilitates easier leveling and mounting. The guitar hanger disclosed herein solves these problems and others.

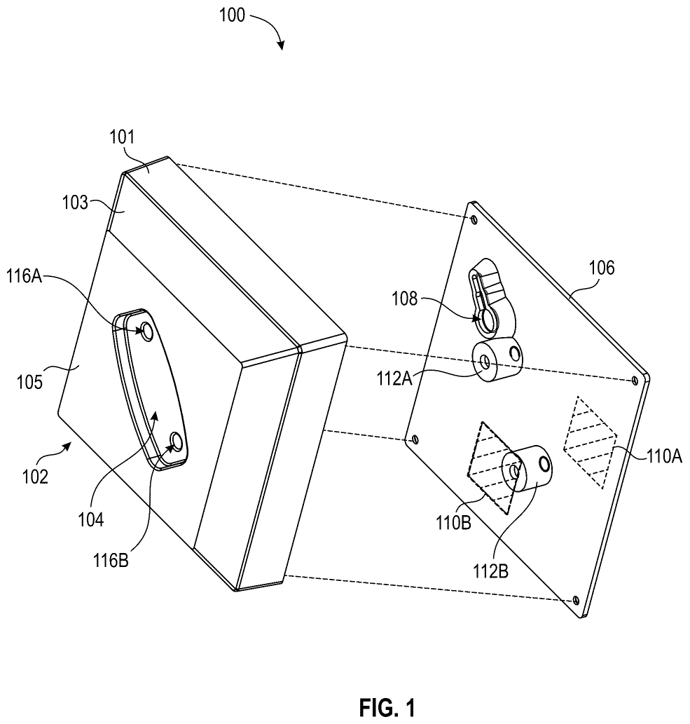

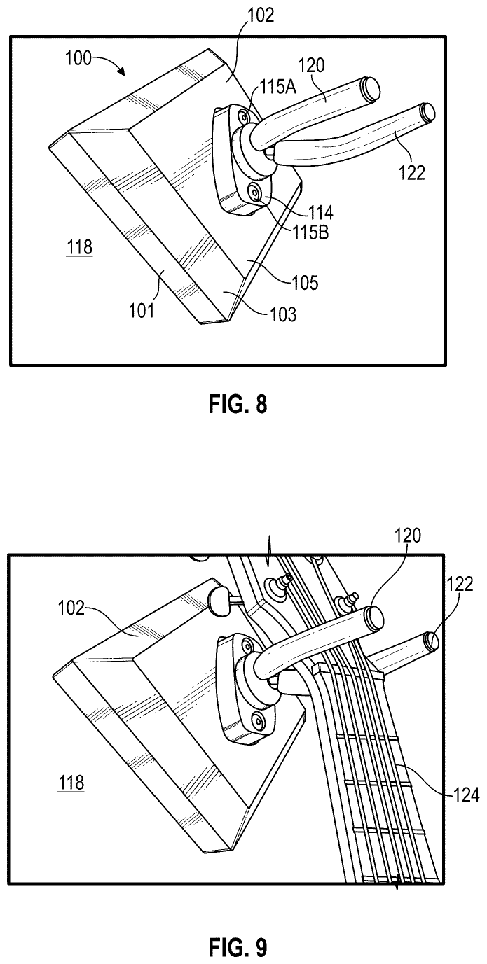

Referring to FIGS. 1-10, in some embodiments, a guitar hanger 100 comprises a housing 102 comprising a guitar mount receiver 104, and a base member 106 couplable (e.g., screws, clips, etc.) to the housing 102, the base member 106 comprising a receiving aperture 108 and may comprises one or more anti-slip portions 110A-B, although not required. The base member 106 further comprises one or more threaded receivers 112A-B for receiving screws of a guitar mount 114 (FIGS. 8-9) that is coupled to the guitar mount receiver 104. As will be described in more detail later herein, a user may install a drywall hook, small screw, or other wall anchor in a wall, and may then hang the guitar hanger 100 thereon by coupling the hook, screw, or anchor to the receiving aperture 108 of the base member 106.

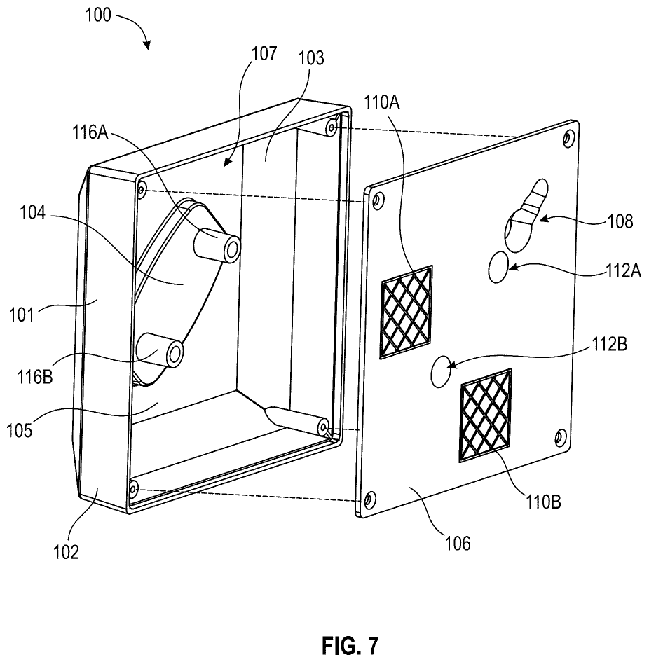

The guitar mount receiver 104 may be configured as an indentation (i.e., recessed) in the front surface 105 of the housing 102. Although the indentation is not required, it aids in properly aligning a guitar mount 114 and securing it to the guitar mount receiver. The guitar mount receiver 104 comprises screw apertures 116A-B that align, respectively, with the threaded apertures 112A-B of the base member 106. In some embodiments, the screw apertures 116A-B may be formed from protrusions that extend rearwardly (as best seen in FIG. 7) from the guitar mount receiver 104, the protrusions aligning or mating with the threaded receivers 112A-B. As shown in FIGS. 8-9, a user may place a guitar mount 114 in the guitar mount receiver 104, and may then secure the guitar mount 114 to the housing 102 by feeding screws 115A-B through the respective screw apertures 116A-B and into the threaded apertures 112A-B of the base member 106.

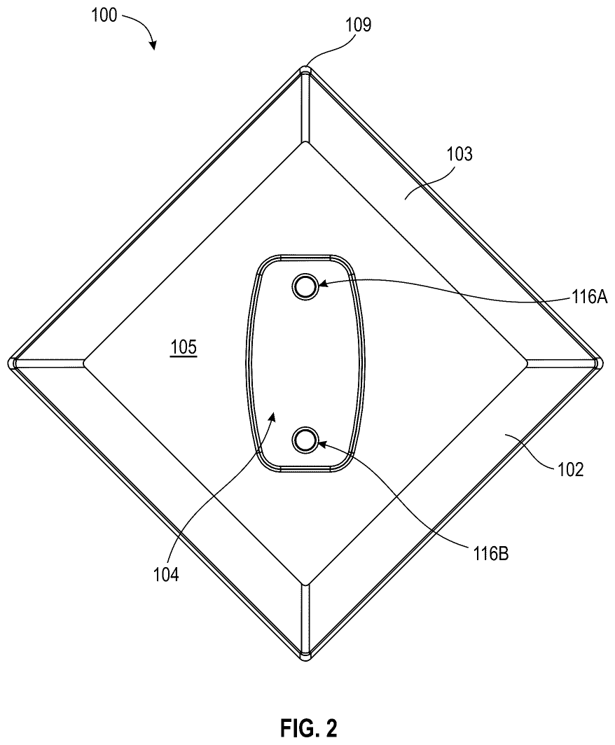

Returning to FIG. 2, the guitar hanger 100 is configured to secure to the wall in a diamond position (i.e., corner at the top). However, it will be appreciated that, in some embodiments, the guitar mount receiver 104 may be configured so as to allow different positioning of the guitar hanger 100, such as with an edge of the housing 102 being positioned to be flat on top, rather than a diamond position. However, the diamond position facilitates easy gravitational leveling of the guitar hanger 100 when positioned on a drywall hook, screw, etc.

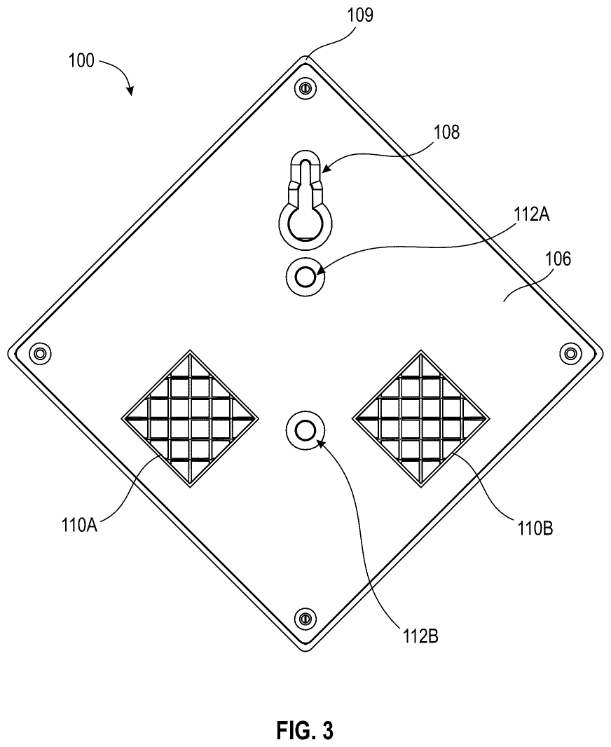

FIG. 3 illustrates a rear elevation view of the guitar hanger 100. As understood, the positioning of the receiving aperture 108 allows the guitar hanger 100 to hang in the diamond position (i.e., corner at the top). In other words, the receiving aperture 108 is positioned proximal to a first corner 109 (i.e., closer to the first corner in relation to the other corners). This places the first corner at the top when suspended by a drywall hook or screw in the receiving aperture 108. One benefit of the diamond position is that the guitar hanger 100 self-levels. In other words, by utilizing a single drywall hook to couple with receiving aperture 108, gravity causes the guitar hanger 100 to level, eliminating the need for precise measurement and leveling using tools. Additionally, the receiving aperture 108 is preferably recessed into the base member 106, which allows the base member 106 to abut the wall without rocking or tilting (i.e., hang flush), which also allows the anti-slip portions 110A-B to perform ideally as well, as discussed later. Further, the shape of the receiving aperture may be tapered, which ensures that the hook, nail, or screw is fully-seated within the receiving aperture 108, preventing or reducing incorrect hanging by a user during installation.

Additionally, to prevent unwanted swaying, the base member 106 may comprise anti-slip portions 110A-B. The anti-slip portions 110A-B may comprise rubber, silicone, adhesives, hooks and loops (e.g., Velcro®), or other non-slip textures or temporary fasteners that aid in preventing movement of the guitar hanger 100 in relation to the wall on which it is mounted. In some embodiments, one or more strips of double-sided adhesive tape may be adhered to the base member 106 to prevent unwanted swaying.

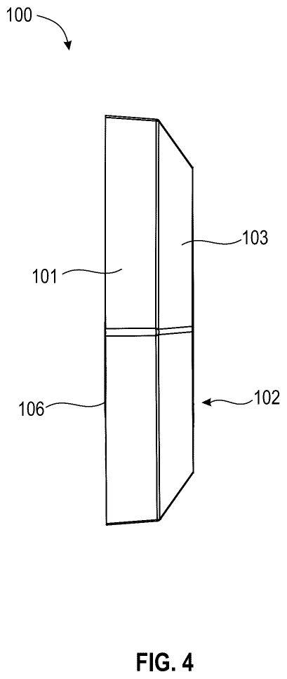

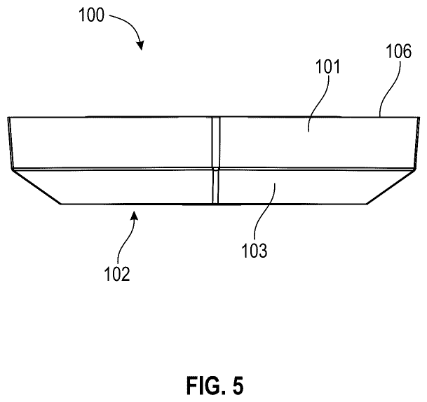

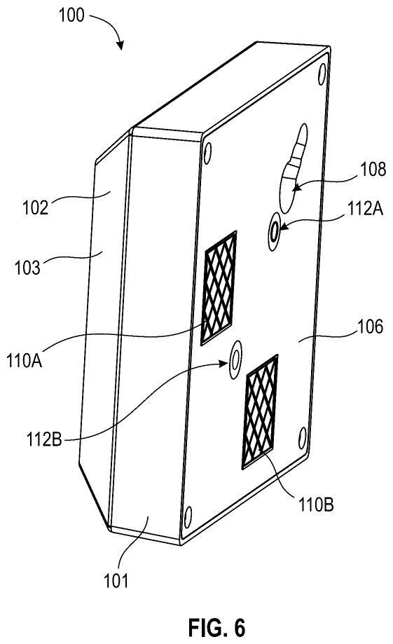

FIG. 4 illustrates a left side elevation view of a guitar hanger 100, the right side being a mirror image thereof. FIG. 5 illustrates a top plan view of a guitar hanger 100, the bottom plan view being a mirror image thereof. FIG. 6 illustrates a rear, partial bottom, right-side perspective view of a guitar hanger 100.

FIG. 7 illustrates a rear, partial bottom, right-side exploded perspective view of a guitar hanger 100. As shown, the housing 102 may comprise a first outer wall 101, a second outer wall 103 tapering from the first outer wall 101, and a front surface 105 on the second outer wall 103, the front surface 105 comprising the guitar mount receiver 104. As shown, this configuration forms an inner void 107. The inner void 107 provides space for the recessed portion of the guitar mount receiver 104, the screw apertures 116A-B, the recessed portion of the receiving aperture 108, as well as the one or more threaded receivers 112A-B, all of which is enclosed between the housing 102 and the base member 106 when assembled.

FIGS. 8-9 show the guitar hanger 100 in use. FIG. 8 shows the guitar hanger 100 coupled to a wall 118, with a guitar mount 114 coupled to the guitar mount receiver 104 of housing 102, the guitar mount 114 comprising a first arm 120 and a second arm 122 extending therefrom. As shown in FIG. 9, the first and second arms 120, 122 cradle the neck and headstock of a guitar 124.

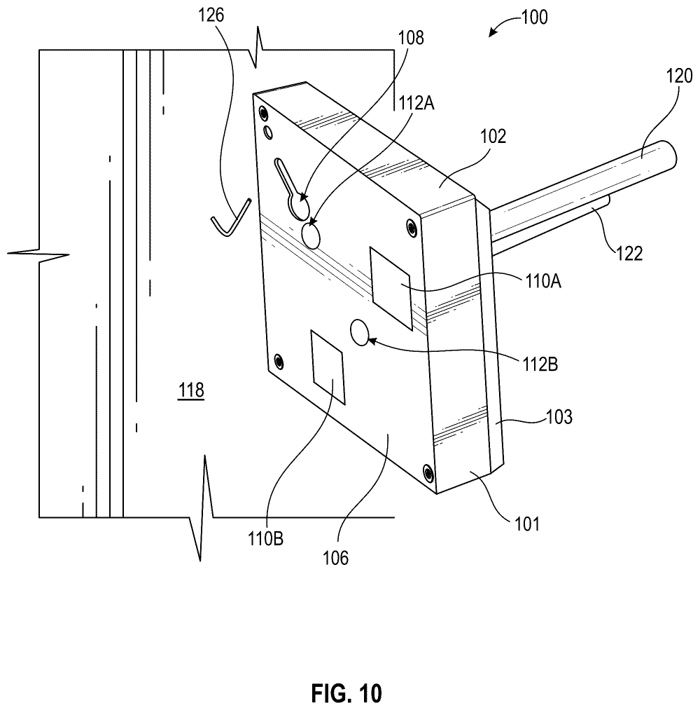

FIG. 10 illustrates a method of attaching the guitar hanger 100 to a wall 118. In other words, instead of screwing the guitar mount 114 directly to the wall 118, as is done in the prior art, the present disclosure includes the housing 102 and base member 106 that allow the guitar hanger 100 to mount to the wall using a single hook 126, nail, screw, etc. As a result, less damage is caused to the wall while still securely holding the guitar 124, overcoming the prior art. In other words, the guitar mount 114 is coupled to the housing 102 via the guitar mount receiver 104, screw apertures 116A-B, and threaded receivers 112A-B. A single drywall hook 126 may be inserted into the wall 118, forming a very small hole—smaller than the typical screws used to mount guitar mounts 114. As appreciated, a first portion of the drywall hook, nail, or screw is inserted into the wall, with a second portion extending from the wall 118 (as best seen in FIG. 10) so as to be insertable into the receiving aperture 108.

The receiving aperture 108 is then mated with the drywall hook 126, with the guitar hanger 100 being suspended and hanging on the drywall hook 126. The weight and diamond configuration of the guitar hanger 100 cause it to self-level, eliminating the need for levels and other tools. A guitar 124 may then be suspended from the first and second arms 120-122, as shown in FIG. 9. If desired, a user may press the base member 106 against the wall to engage any anti-slip portions 110A-B. In some embodiments, a protective liner (adhesive liner) may first be removed from the anti-slip portions 110A-B to expose an adhesive or other non-slip surface to aid in preventing movement of the guitar hanger 100 once placed on the wall 118.

While shown as generally cuboidal in shape, it will be appreciated that the guitar hanger 100 may be any other geometric shape without departing herefrom. Additionally, while the housing 102 and the guitar mount 114 are shown as separate components that are screwed or otherwise fastened together, it will be appreciated that other configurations may be used without departing herefrom, including units of single manufacture or units that are permanently adhered to the housing 102, among other configurations. Further, it will be appreciated that the guitar mount 114 may be a prior art hanger that is coupled to the housing, or may be of a different design so long as it is configured to support a guitar by the neck and head.

Therefore, it will be appreciated that the guitar hanger 100 disclosed herein solves the need for a guitar hanger that does not require drilling multiple holes into a wall or other surface, and that provides self-leveling, overcoming the prior art.

It will be appreciated that systems and methods according to certain embodiments of the present disclosure may include, incorporate, or otherwise comprise properties or features (e.g., components, members, elements, parts, and/or portions) described in other embodiments.

Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A guitar hanger, comprising:
a base member comprising a receiving aperture;
a housing couplable to the base member, the housing comprising a guitar mount receiver; and
a guitar mount configured to be received in the guitar mount receiver, the guitar mount comprising a first arm and a second arm extending outwardly therefrom, the first arm and second arm configured to support a neck of a guitar therebetween;
wherein the receiving aperture of the base member is configured to receive a hook protruding from a wall.

2. The guitar hanger of claim 1, wherein the base member further comprises one or more anti-slip portions.

3. The guitar hanger of claim 1, wherein the receiving aperture comprises one or more screw apertures.

4. The guitar hanger of claim 3, wherein the one or more screw apertures are configured to align with one or more threaded receivers, respectively, on the base member.

5. The guitar hanger of claim 4, wherein the one or more screw apertures and the one or more threaded receivers are positioned within a void of the housing.

6. The guitar hanger of claim 5, wherein the void is formed by a first outer wall, a second outer wall tapering from the first outer wall, and a top.

7. The guitar hanger of claim 1, wherein the receiving aperture is proximal to a first corner.

8. A guitar hanger, comprising:
a base member, comprising:
a receiving aperture positioned proximal to a first corner, and
one or more threaded receivers;
a housing couplable to the base member, the housing comprising:
a guitar mount receiver, and
one or more screw apertures within the guitar mount receiver, the one or more screw apertures configured to align, respectively, with the one or more threaded receivers of the base member;
a guitar mount configured to be received in the guitar mount receiver, the guitar mount comprising:
a first arm extending outwardly, and
a second arm extending outwardly,
wherein the first arm and second arm are configured to support a neck of a guitar therebetween;
wherein the receiving aperture of the base member is configured to receive a hook, nail, or screw protruding from a wall.

9. The guitar hanger of claim 8, wherein the base member further comprises one or more anti-slip portions.

10. The guitar hanger of claim 8, wherein the one or more screw apertures and the one or more threaded receivers are positioned within a void of the housing.

11. The guitar hanger of claim 10, wherein the void is formed by a first outer wall, a second outer wall tapering from the first outer wall, and a top.

12. A method of using a guitar hanger to hang a guitar, the method comprising:
inserting a first portion of a drywall hook, nail, or screw into a wall, leaving a second portion exposed and extending from the wall;
positioning the guitar hanger with a base member facing the wall;
inserting the second portion of the drywall hook, nail, or screw into a receiving aperture in the base member, the guitar hanger being suspended by the second portion of the drywall hook, nail, or screw; and
placing a neck of the guitar between a first arm and a second arm extending outwardly from the guitar hanger.

13. The method of claim 12, wherein after the step of the guitar hanger being suspended, applying pressure to the base member to engage one or more anti-slip portions with the wall.

14. The method of claim 13, wherein before applying pressure to the base member, removing an adhesive liner from the one or more anti-slip portions to expose an adhesive.

15. The method of claim 12, wherein before positioning the guitar hanger with the base member facing the wall, coupling a guitar mount to the guitar hanger.

16. The method of claim 12, wherein the guitar hanger is suspended in a diamond position.
